(19) United States
(12) Patent Application Publication
(10) Pub. No.: US 2025/0053574 A1
(43) Pub. Date: Feb. 13, 2025

(54) Connector For Process Mining And Other Tools

(71) Applicant: Venetia Partners, LLC, Canonsburg, PA (US)

(72) Inventors: Stephen Carpenter, North Royalton, OH (US); Thomas Ring, Boardman, OH (US); Brent Summerlin, Flower Mound, TX (US); Matthias Schiffer, Alpharetta, GA (US); Robert Gotschall, Hummelstown, PA (US); Mark Miller, Brdenton, FL (US)

(73) Assignee: Venetia Partners, LLC, Canonsburg, PA (US)

(21) Appl. No.: 18/231,625

(22) Filed: Aug. 8, 2023

(51) Int. Cl. G06F 16/26; G06F 16/2458

(52) U.S. Cl. CPC G06F 16/26; G06F 16/2474

(57) ABSTRACT

Documents and other process area events in an Enterprise Resource Planning (ERP) system are extracted according to a knowledge table. The extracted events are stitched together in a timeline order, placed in a transport container (or otherwise transmitted), and input to, for example, a process mining or process intelligence tool. The tool utilizes any of AI, Machine learning, or other techniques to evaluate processes and/or documents represented by the extracted events, and triggering alerts or messages based on the evaluation. The tool may be a task mining tool and/or provide information or suggestions for improving the document or process represented by the document(s) and may prepare and display (or provide for display) a visual model of the evaluated process or document and may highlight anomalies therein.

### COPYRIGHT NOTICE

A portion of the disclosure of this patent document contains material subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Replicating data from one system to another can be a slow, time-consuming, and tedious process, particularly if there is a large amount of data or variations of data or table structures to be identified, replicated, and/or re-structured. In the case of process mining, data replication or transfer is more than copying or updating data from a first location to a second location and may include re-structuring the data (e.g., for a specific tool). Further finding the appropriate data within a system is typically both tedious, time-consuming, and fraught with errors that can be difficult to detect and correct.

### SUMMARY

The present inventors have realized need to provide faster and more accurate transfer of data from an existing system (e.g., SAP AP) to another system for intelligent process mining and other functions. The present inventors have further recognized the need for faster execution of process mining, process intelligence, and/or other tools/related functions which is provided by a timeline stitched input such as a timeline ordered document process (or timeline ordered events of a document or process, for example). The present application describes many embodiments and no single feature or component of one embodiment is exclusive thereto or required in any other embodiment even if described or implied as important to a particular embodiment.

In one embodiment, retrieving a plurality of documents from an SAP system, determining a timestamp associated with each document, stitching the documents (or indicia of each document) together in a timeline according to the timestamps, and entering the stitched documents into a process mining or process intelligence tool for evaluation of efficiency or outcomes represented by the stitched documents.

In another embodiment, a method comprising determining a plurality of records from a plurality of source tables or views in a source system wherein each record comprises at least one instance of a document or process, determining a timestamp associated with each record of the plurality of records, stitching the records together in a timeline of records according to the timestamps, and entering the stitched records into a tool (e.g., process mining or process intelligence tool) for evaluation of efficiency or outcomes represented by the stitched records.

In another embodiment a process mining or process intelligence tool is configured or applied to utilize advanced analytics on an automatically created timeline of events of a document or process and produce a model (e.g., a product or evaluation) of the document or process. The model may be a visual model. The visual model may include a series of interconnected nodes with information or changes relative to the document or process defining an instance of the document or process and may include connectors between nodes and to other documents or processes that provide input utilized for the changing the document/process or providing information to be contained in the document/process. The visual model may include highlighted sections or paths for which the timeline of events represents a variation of the document outside a predetermined set of one or more parameters or variation in path or timing not typically followed for similar documents/processes.

In yet another embodiment, a process mining or process intelligence tool configured to receive an automatically created timeline of a document or process in an Enterprise Resource Planning (ERP) System, and then use the timeline for one or more functions of the tool. Such functions may include applying machine learning, Artificial Intelligence, or other analytics to determine issues, suggest improvements and report of efficiencies, cost, and other characteristics of one or more of the documents or processes.

In yet another embodiment, a method including the steps of importing a package comprising at least one of development objects and custom tables configured to retrieve records and documents from a system hosted on an Enterprise Resource Planning (ERP) platform, modifying the package and/or development objects and/or custom tables for extraction of records and/or documents from the hosted system, applying the modified package and/or development objects to retrieve the records and documents, stitching the records and documents together in a timeline according to timestamp data associated with each record and document, entering the stitched records into an intelligence tool configured to compare at least one of a node, document, or process represented by the stitched records and documents to a plurality of data points comprising at least one of same and/or similar nodes, documents, or processes in the same system and the same or similar nodes, documents, or processes in other systems, and preparing for display at least one of a report and a visual representation identifying anomalies within the stitched records and documents. Such method may further include the step of displaying the at least one of the report and visual representation.

In yet another embodiment, a process mining tool configured to receive an automatically created timeline of events, map the events, analyze and optimize the events, monitor changes in the events based on a newly automatically created timeline of events, alerting to changes or exceeding thresholds in the events, and simulating a document or process memorialized by the events.

In yet another embodiment, a process mining or process intelligence tool configured to display at least one of a workflow, process, or portion thereof from a system hosted on an ERP, wherein the workflow, process, or portion thereof comprises automatically generated records stitched together in timeline.

In yet another embodiment, a method comprising the steps of retrieving a plurality of training records from at least one system hosted on one or more ERPs or other platforms, determining at least one of a set of rules, trends, averages and/or statistical information from the records, automatically retrieving a set of customer records from a customer system hosted on an ERP, and evaluating the customer records with a process mining or process intelligence tool based on the rules, trends, averages and/or statistical information from the records.

In yet another embodiment, a method comprising creating or updated a training database via a timeline stitched set of records from a plurality of tables in an ERP hosted system, wherein the stitched set of records reflect at least one of a document or process in the system.

In yet another embodiment, a client site customization tool configured to modify a connector that automatically extracts records from a system and stitch the records together in a timeline for use in a process mining or process intelligence tool, wherein the modification comprises identifying at least one client site specific configuration, custom data dictionary, and/or other development object, and changing at least one of a retrieval and stitching process in the connector to match the identified development object(s).

In yet another embodiment, a connector, comprising a graphical user interface including selectable fields for information regarding customized fields and/or tables for a document or process in a source system, an extractor configured to automatically extract baseline information and information contained in the customized fields and/or tables, along with timeline information for the information extracted, a stitching device that places the extracted information in a transport container according to the timeline information, and a transport mechanism configured to output the transport container to a tool.

And, in yet another embodiment, a connector configured to extract a plurality of records from multiple tables in a system, stitch the plurality of records together into a timeline, and transfer the stitched timeline to a tool (such as a process mining or intelligence tool).

The various embodiments, and others based on the present disclosure, may include or be realized as, for example, a device, apparatus, mechanism, etc., implementing, for example, a method the steps including determining a plurality of records from a plurality of source tables and/or views in a source system wherein each record comprises at least one instance of a document or process, determining a timestamp associated with each record of the plurality of records, stitching the records together in a timeline of records according to the timestamps, and entering the stitched records into a process mining or process intelligence tool for evaluation of efficiency or outcomes represented by the stitched records. Further, the stitched records as mainly described herein are timeline ordered, however, the same techniques may be utilized to stich records in other orders or groupings such as reverse timeline, a predetermined timing (out-of-timeline), based on size, type, action, costs, ROI, or any other criteria or combination of criteria as may be helpful or required by a specialized tool or other downstream process.

Portions of these and other embodiments, whether a device, method, or other form, may be conveniently implemented in programming on a general purpose computer, or networked computers, and the results may be displayed on an output device connected to any of the general purpose, networked computers, or transmitted to a remote device for output or display. In addition, any components of any embodiment represented in one or more computer program or module(s), data sequence(s), and/or control signal(s) may be embodied as an electronic signal broadcast (or transmitted) at any frequency in any medium including, but not limited to, wireless broadcasts, and transmissions over copper wire(s), fiber optic cable(s), and co-ax cable(s), etc.

### DESCRIPTION OF THE DRAWINGS

A more complete appreciation of the various embodiments and many of the attendant advantages thereof will be readily obtained as the same becomes better understood by reference to the following detailed description when considered in connection with the accompanying drawings, wherein:

FIG. 1 is a block diagram according to an embodiment;

FIG. 2 is a flow chart according to an embodiment;

FIGS. 3A and 3B are illustrations of a user interface according to an embodiment;

FIG. 4 is a diagram illustrating a connector and various related end-user products according to embodiment.

### DESCRIPTION

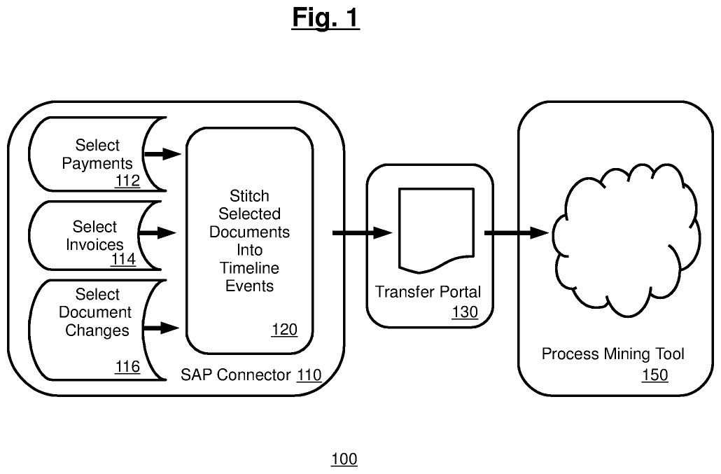

Referring now to the drawings, wherein like reference numerals designate identical or corresponding parts, and more particularly to FIG. 1 thereof, there is illustrated a system 100 that utilizes a connector 100 according to an embodiment. The connector accesses information from a source system such as select payments 112, invoices 114, and/or document changes 116. Although generally defined as documents (e.g., Accounts Payable (AP), Accounts Receivable (AR)), and others, the accessed information may be related to any document, process, or device, including factory equipment, automation, robotics (RPA and mechanical/software devices such as manufacturing, personal assistants, etc.), chat session operators, RPA devices or digital workforce personnel for operating chat sessions for sales, customer service, technical support, making reservations and/or modifying reservations, etc. or other devices that either provide information or have information available that may be analyzed or used for process improvement, decision making, Return on Investment (ROI), or other analysis/evaluation, etc.

A stitching device 120 receives the accessed information, which is retrieved from various tables, records, or other storage in the source system. The accessed information is, for example, change points in a document or process maintained on the source system. The source system may be, for example, SAP or other ERP. In one embodiment, the accessed information may be feedback or product of a digital worker, RPA, or other process (and may, for example, be part of a feedback loop from the tool 150 or other downstream user back to the tool). In another embodiment, the accessed information may be feedback or information from a device, factory and/or machine such as a robotic arm or other production mechanism at a manufacturing facility.

Typically, the information may be a combination of multiple records and a plurality of tables within the source system and/or feedbacks from one or more machines, processes or (or other sources) in any combination. The accessed information may be any or all information related to any document or process in the source system. The accessed information may be a selection provided via manual input or selected from knowledge of the source system (e.g., knowledge of where in the system the desirable information is located) and/or knowledge of tool 150 or other use. The selection may be memorialized, for example, in a knowledge table (e.g., knowledge table 452) or other storage.

The stitching device 120 takes the retrieved information and stitches it together into a timeline that reflects the document or process over a predetermined period of time (e.g., an invoice from receipt until payment or quarterly report). The predetermined period of time may be a set duration, keyed into the life of a document or process, or any portion of the document or process, such as inception until payment, payment until delivery, inception until the present time, and/or regularly provided at intervals (e.g., hourly, daily, weekly, quarterly, etc.). In one embodiment, the retrieval of information utilizes a set selection of relevant information (e.g., payments, invoices, document changes) that is triggered by an event. Such event may be, for example, a number of transactions or changes on the source system, a reporting date (e.g., quarterly report or staff meeting), or other interval.

The stitched information may be output to the process mining tool 150 (or other tool(s)), or be provided as or used in a report without use of the tool. In one embodiment, the output is split (either duplicated, segmented, or both) and sent to different tools, such as, for example, competing process mining tools or process mining tools that specialize or provide better results for different analysis.

In yet another embodiment, the connector 110 includes multiple resource packages each configured to identify set of information (e.g., tables, fields, etc.) for a respective tool or different respective products of one or more tools. Ultimately, in one embodiment, each resource package is, for example, a guide to the information utilized in the stitched output to one or more tools or one or more results from a tool or tools. The process mining tool 150 may be configured to perform any number of functions. The process mining tool 150 is, for example, a tool based on Artificial Intelligence (AI), Machine Learning (ML), and/or any number of routines or processes that utilize big data or large datasets to identify variations in processes or make any type of determination analysis as to process, document flow, RPA, machine (virtual or physical), ROI, digital work efficiency, and/or content.

The process mining tool 150 may be, for example, any of one of ABBYY Timeline, Workfellow Process Intelligence, Celonis Execution Management System, IBM Process Mining, UiPath Business Automation Platform, Software AG, SAP Signavio, and MEHRWERK. The process mining tool 150 may be pre-tool or pre-processor that further identifies, highlights, or supplements the stitched timeline, and then proceeds to invoke one or more tools such as ABBYY Timeline, Workfellow Process Intelligence, Celonis Execution Management System, IBM Process Mining, UiPath Business Automation Platform, Software AG, SAP Signavio, and MEHRWERK. The tool 150 may be, for example, SS&C Blue Prism. The tool 150 may be a tool that has not yet been developed and may be configured for any number tasks, task mining, process intelligence, or other projects, analysis, and/or evaluations, for example.

In one embodiment, the tool 150 is configured to evaluate and provide a vendor's RPA landscape based on automatically retrieved source system records and tables stitched into a timeline and provided to the tool 150. In one embodiment, the tool provides a landscape, visual, or other information regarding an end-user's business processes, such as the efficiency or return on investment of a digital workforce. For example, a digital workforce manning chat lines or sessions (e.g., chatbot, chatbox, etc.) for product support or sales—the efficiencies of which may be measured or compared, for example, against real-time human operated call center costs. The efficiency of a combination of digital workers and human operator call-centers may be evaluated using AI to determine the most efficient combination of digital and human call center operators at different times of the day in various regions. The documents/processes and/or tables/fields from which information is retrieved in such cases, may include, for example, engagement of the user, sales results, problem resolution, and time to resolution.

Many other functions, evaluations, or processes may be performed by the tool(s), the examples herein only scratch the surface of what they may be used for. However, each function, evaluation or process, whatever its goal or end result is determined more reliably, efficiently, faster, and at much lower cost using the connector. The connector may include modifications to account to implementation specific or unique features of the source system, and, via stitching, specific or unique requirements of the tool.

In one embodiment, the connector feeds a real-time or near real-time assessment of critical infrastructure, such as electric utilities, [[other utilizes water, gas, stocks on hand at, for example, a distribution center]], energy generation and/or monitoring. The connector retrieved information may be from the source system or a combination of source systems, monitors, sensors, etc. In one embodiment, the connector reaches beyond the source system for additional information such as weather. For example, when monitoring critical infrastructure such as hydro-electric facility, the connector may be configured to retrieve information from the source system and an outside system such as rainfall or predicted rainfall in the facility's water-shed.

In one embodiment, the connector may be configured to retrieve additional information from a partner or paid information service (e.g., select outside or additional non-source system information). Such additional information, along with source system information, may then be stitched in the appropriate form (e.g., timeline) for the tool. Accordingly, a timeline of source system information and outside information stitched together (e.g., different or order or format than received) and output to the tool 150. In yet another embodiment, the tool operates on a source system derived stitched container in combination with a separately received container from an outside system. The container from the outside system may itself be stitched either in timeline (e.g., timeline id, according to record timestamp, etc.) or other format utilized by the tool. In one embodiment, separate containers received by the tool may be preprocessed and stitched together or the tool may be arranged to take information from any number of containers and stitch them together as needed. In yet another embodiment, the tool receives a container from the source system and non-source system information to produce the product, evaluation, or model.

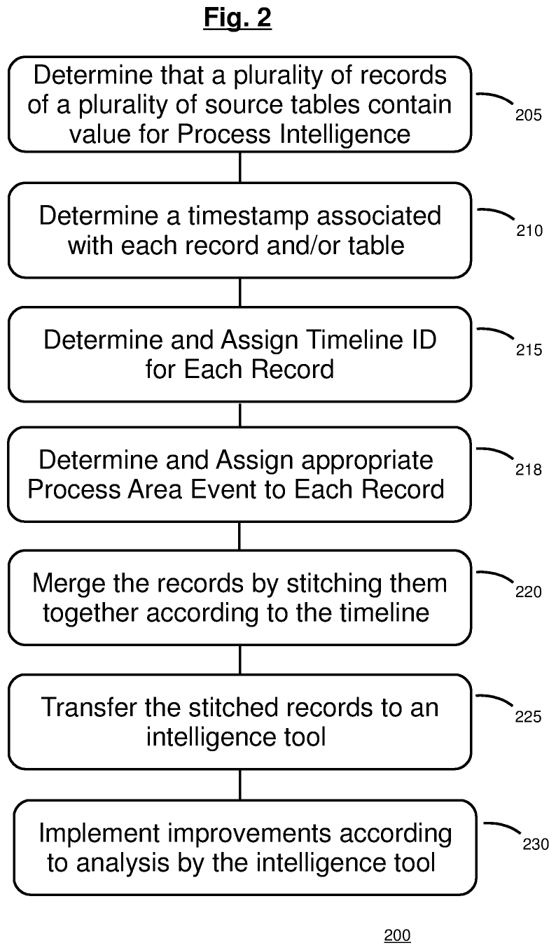

FIG. 2 is a flow chart 200 according to an embodiment. At step 205, records or other information, such as a plurality of source tables are determined. The records or other information, for example, consist or include information of value for process intelligence. The determined [(or otherwise selected)] information may be memorialized, for example in the knowledge table 452 which may be used as a template [(or entered into a template)] to quickly and automatically retrieve from the source system. A link to an additional source system or an outside system may also be provided and located in the knowledge table. In other embodiments, the determined information may be specifically assigned variables, classes, or instances within programming of the connector (or hardwired into an electronic device connector). In yet other embodiments, the knowledge table is a table of indirect references to where the knowledge is located or a combination of references and determined locations, for example. In one embodiment, the determined information is a map for retrieving and extracting information either required, useful, or optional for use in the tool.

At step 210, a timestamp associated with each record and/or table is determined. The timestamp is, for example, a date and time which the record was last modified [or touched, copied, viewed, accessed, or utilized].

At step 215, a timeline ID is determined and assigned for each record. The timeline ID is, for example, an assigned timeline ID that establishes a position where the associated record or other information [is stitched into place (e.g., with a container, file, or other transport mechanism, for example)]. The timeline ID may be, for example, a function of the timestamp determined for the record and/or relative to other determined timestamps.

At step 218, an appropriate process area event is determined and assigned to each record. The process area event may be, for example, any of a predetermined set of events related to the record in question and/or events recognized by the tool (e.g., process mining, process intelligence, RPA, etc.). Such events include, for example, key process area events, etc.

At step 220 The records are stitched together according to the timeline. The records may be stitched together in a container which may be, for example, a .CSV file. In one embodiment a .CSV file with a header for each timeline id and record information. In one embodiment, tool or report preprocessing may be performed and placed in the container.

At step 225, The stitched records are transferred to an intelligence tool (e.g., process mining or process intelligence tool such as ABBYY Timeline, Workfellow Process Intelligence, Celonis Execution Management System, IBM Process Mining, UiPath Business Automation Platform Software AG, SAP Signavio, and MEHRWERK, etc.)

At step 230, Implement improvements according to analysis by the intelligence tool. Such improvements may include, for example, any RPA adjustment, re-assigning tasks to/from digital workforce members or between different types of digital workers, adjusting digital workforce staffing levels, purchasing or licensing additional digital workers, changing maintenance schedules (which may be either digital workers/robots or physical devices), recommending upgrades (or downgrades) in material supplies, manufacturing processes, and/or related equipment.

For example, in the aforementioned call center/digital worker chatbox example, the suggestion may be an AI determined analysis of the automatically created timeline stitched records/information that indicates an increase in efficiency using certain types of responses to questions or scenarios encountered in the chatbox and/or faster elevation to a live agent if certain conditions are presented in the chatbox (and/or, for example, by a chatbot). The suggestion may be a change from a maintenance schedule for a factory automation device to an AI predictive/proactive maintenance and any such suggestions or results may include an ROI analysis for any suggested change.

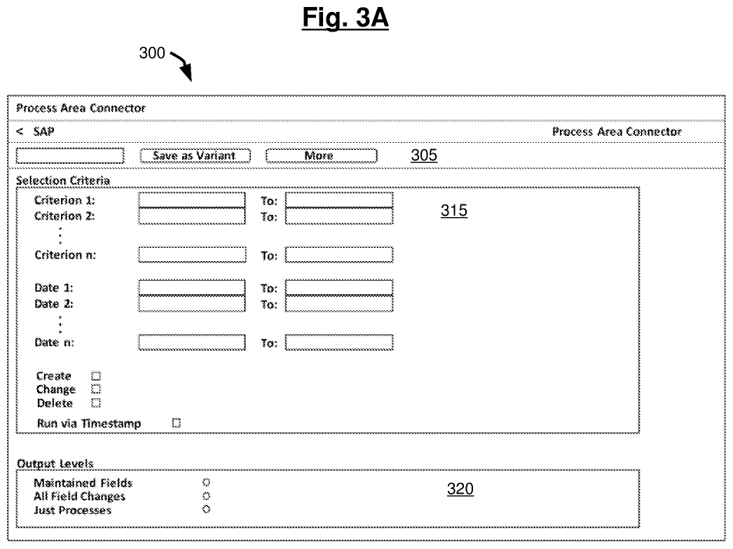

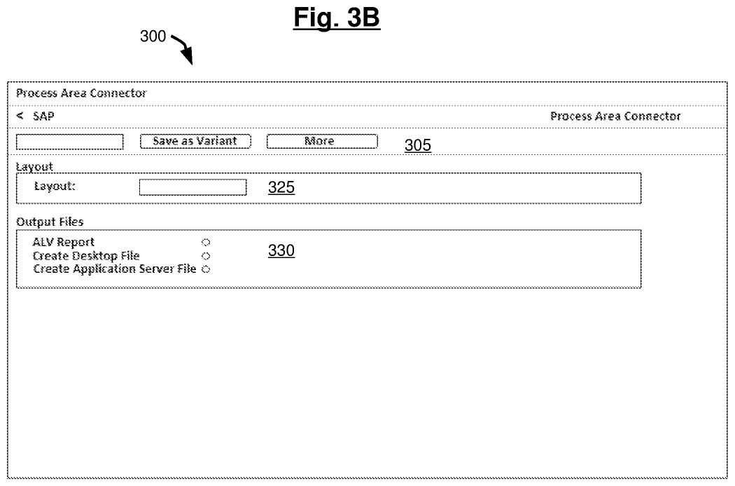

FIGS. 3A and 3B are illustrations of a user interface 300 according to an embodiment. As shown in FIG. 3A, a Process Area Connector user interface 300 on an SAP platform illustrating and providing for the selection of document type and a number of data selections and locations[*]. The selections and location may provide, for example, customization capability to allow an organization's specific fields of importance to be used in selection of data. Further, a selection screen may be used to restrict data selection when creating the report or extract files. It may also be used to determine the correct output, either file or ALV (See FIG. 3B).

The Process Area Connector user interface 300 includes save and save as variant 305. An Invoice or Non Invoice Timeline ID may also be included.

As with each user interface portion discussed herein, other features or selections may be provided to customize an interface for particulars of a source system. In one embodiment, a user interface for selection of AR (or AP) tables or fields in a source system such that the selections are utilized in an automatic retrieval of records from a source system are stitched together in a timeline and provided to a process mining, process intelligence, or other tool. The selection of AR (or AP in an AP embodiment, or other connector types) tables and/or fields is illustrated with the box entitled Selection Criteria 315. As illustrated, the selections may generally be made in a range (e.g., over dates, types, etc. or other factors/ranges). Further, the selection may be directed toward any of the other connectors discussed herein such as STP, OTC, PTP, and/or a connector built for another document or process. Further yet, the interface and selection may be built for a combination of AR/AP or the other connectors (e.g., any of the connectors discussed herein or a combination thereof). Output levels 320 provides for a range of change information from specific fields to all changes, or just processes.

The user interface is continued in FIG. 3B, where the with selections for Layout 325 and Output Files 330 which may be embodied as illustrated as an indicator for selections for Output file names and types (Output Files 330). An organization or other end user may use this to define and select various ALV layouts for focusing on certain columns as needed or desirable.

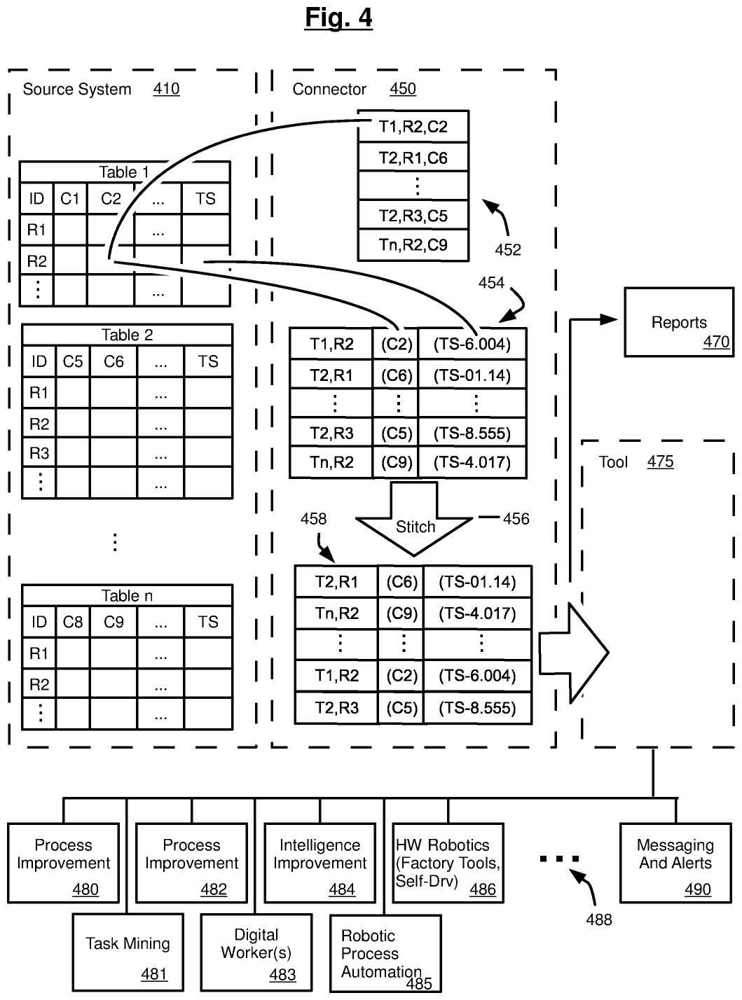

FIG. 4 is a diagram illustrating a connector and various related end-user products according to embodiment. As noted further above, knowledge for retrieving the relevant, most relevant, desire, or other tables, records, or information may be maintained in knowledge table 452. The knowledge table itself may be stored on the source system and retrieved or portions retrieved by the connector as a preliminary step before accessing information. In yet another embodiment, the knowledge table is maintained off-site and accessed by or loaded into the connector. A user interface may be developed to rewrite, add to, delete, or otherwise maintain the knowledge table.

In the illustrated embodiment, connector 450 is shown accessing the knowledge table 452 with respect to a table, row, and column (Table 1, Row 2, Column 2) of the source system 410. The record or other information at that location is deposited, for example, in a temporary table 454 (e.g., (C2)) of the connector (or otherwise maintained in a structure, variable, object, or other storage accessible by the connector, and/or maintained in an accessible off-site location). Further a timestamp of the relevant record is also transferred (TS-6.004 in this example). The record transfer continues for each item in the knowledge table and may include, for example, items from a plurality of tables and/or records on the source system. Although not specifically shown in FIG. 4, additional information may further be accessed off-site or from other systems if needed or desired for the tool (e.g., environmental data). Such information may, for example, be located by the tool according to a pointer to an offsite system or gateway along with security credentials (e.g., ID & password) if needed. In another embodiment, a preparation tool may be run to access desired off-site information and storing it in a table identified by and/or known to the knowledge table.

Once the records or other information identified in the knowledge table is available a stitching operation 456 may be performed to bring the information together in a container, file, table or other transport mechanism 458. The stitching operation may begin as soon as the first information is accessed, and then be sorted and stored contemporaneously and/or once all the information is retrieved it may be sorted, meta-data (if utilized) created, and appropriately placed in the container. In one embodiment, the container comprises a .CSV file. The container is then transferred to the tool 475 or provided for reporting (e.g., direct reporting).

The tool 475 is, for example, a process mining, a process intelligence, or other tool and various analysis may be performed. For example, process improvement 480 may be, for example, an AI based analysis that provides suggestions for improving one or more processes related to the records/information that supplied the tool. For example, the analysis may show a backlog of customer service requests consistently occurring near closing time on Friday and the suggestion may include licensing additional digital workers to address that surge in activity and allow them to work into the evening until none or less than a predetermined number of requests remain outstanding. In one embodiment, an adjustment of a digital workforce based on a process mining or intelligence tool result of automatically retrieved records and/or tables recording documents or processes in an ERP system where the records and/or tables (or portions thereof) are stitched together in a timeline and transported to the process mining or process intelligence tool. Similar processing may be performed for other tools or analysis.

In another example, task mining 481 may be performed by analyzing all data points entered or resulting from tasks performed by certain workers (e.g., mechanics, all call-center operators, digital workers in chat boxes, etc.). These data points may be mined to determine what processes/tasks are being performed and which of those work better, for example. Training Database 482 is a feature of yet another embodiment which may, for example, utilize the data and/or results of the process mining or process intelligence in conjunction with the container to improve the database or training database of machine learning or other AI related processes within the tool 475.

In one embodiment, the records/information provided in the container and passed to the tool 475 may comprise all chat conversations held over a predetermined period of time, and the language and technologies described are evaluated against the result obtained (e.g., satisfaction survey) and that analysis used to suggest preferred language routes or ways to approaching or addressing customer needs, and to know when such conversations should be elevated to a live assistant or to the next level of support. The same or similar analysis may applied to support Digital Workers 483.

Intelligence Improvement 484 comprises, for example, the collection of metrics evaluating results of the tool. Such evaluation may include a comparison of the results to other intelligence or mining tools and may be determined on a one-time basis or applied over time to evaluate results as the tool performs more and more of the same or similar functions. Ultimately, such results may be provided back to the process mining or process intelligence tool to adjust parameters, rules, training, or programming for any of a customer, a group of like customers, and/or all users of the tool.

HW Robotics (Factory Tools, Self-Driving, etc.) 486 comprises a collection of applications of results of the process mining or process intelligence tool. For example, feedback or adjustment of processes utilized to command factory automation robotics, self-driving cars, etc. Any number of other tools or processes may be invoked or utilized by (or within Tool 475) as shown by 488. Such tools may be, for example, Blue Prism, Automation Anywhere, UiPath, Workfusion, Nice RPA, Softmotive, Kryon, Contextor, Edgeverve, Kofax, Pegasystems, Redwood, and others, and any such other tools may be included in the comparative evaluation noted above. Further, any such tools may be operated in tandem and have results merged. Messages and Alerts 490 may be generated by the tool or other analysis (including any of 488), such messages/alerts may include notification of staffing levels, throughput, changes in workflow or work environment, changes in work issues, issues solved, new issues, etc.

Knowledge table 452 has access, for example, to all tables/records in an ERP, such as an SAP system. And the systems described herein may be applied, for example, to Accounts Receivable and/or Accounts Payable operations, Order to Cash (OTC) and/or Source to Pay (STP) operations. In SAP, the standard delivered, AR/AP specific tables which include but are not limited to, accounting document data, and any supporting tables that provide context to certain SAP or configured codes, such as Posting Key, etc., or master data such as vendors and customers, etc. For example:

### AR/AP Specific Tables:

BKPF Accounting Document Header
VBKPF Document Header for Document Parking
BSEG Accounting Document Segment
VBSEGD Document Segment for Customer Document Parking
VBSEGK Document Segment for Vendor Document Parking
TBSLT Posting Key Names

STP Specific Tables which include but are not limited to, purchase requisition and purchase order data, and any supporting tables that provide context to certain SAP or configured codes, such as document type, etc., or master data such as vendors and purchasing organizations, etc. For example:

### STP Specific Tables:

EKKO Purchasing Document Header
EKPO Purchasing Document Item
EKET Scheduling Agreement Schedule Lines
EKES Supplier Confirmations
EKBE History per Purchasing Document
EKKN Account Assignment in Purchasing Document
LIKP SD Document: Delivery Header Data
LIPS SD document: Delivery: Item data
RBKP Document Header: Invoice Receipt
RSEG Document Item: Incoming Invoice
MKPF Header: Material Document
MSEG Document Segment: Material
EBAN Purchase Requisition
EBKN Purchase Requisition Account Assignment
VBKPF Document Header for Document Parking
LFA1 Supplier Master (General Section)
TVLKT Delivery: Types: Texts
T158W Long Text for Transaction/Event Type
T156T Movement Type Text
T161T Texts for Purchasing Document Types
T163C Texts for Purchase Order History Categories

OTC Specific Tables which include but are not limited to, sales order, delivery, shipping, and invoice data, and any supporting tables that provide context to certain SAP or configured codes, such as document type, etc., or master data such as customers, company codes, plants, etc. For example:

### OTC Specific Tables:

VBAK Sales Document: Header Data
VBAP Sales Document: Item Data
VBKD Sales Document: Business Data
VBEP Sales Document: Schedule Line Data
VBUK Sales Document: Header Status and Administrative Data
VBUP Sales Document: Item Status
VBFA Sales Document Flow
VBPA Sales Document: Partner
PRCD_ELEMENTS Pricing Elements
KNA1 General Data in Customer Master
VBRK Billing Document: Header Data
VBRP Billing Document: Item Data
LIKP SD Document: Delivery Header Data
LIPS SD document: Delivery: Item data
KNVV Customer Master Sales Data
TVAKT Sales Document Types: Texts
TVLKT Delivery: Types: Texts
TVTKT Transport Type: Description
T161T Texts for Purchasing Document Types
T024E Purchasing Organizations
T158W Long Text for Transaction/Event Type
T685T Conditions: Types: Texts
TTXIT Texts for Text IDs

PTP Specific Tables which include but are not limited to, planned orders, production orders, operations, and status data, and any supporting tables that provide context to certain SAP or configured codes, such as document type, etc., or master data such as plant, BOMs, materials, etc. For example:

### PTP Specific Tables

PLAF Planned Order
AFKO Order Header Data PP Order
AFPO Order Item
AFVC Operation within an order
AFVU DB structure of the user fields of the operation
AFVV DB structure of the quantities/dates/values in the operation
AFFL Work Order Sequence
RESB Reservation/dependent requirements
AUFK Order master data
JCDS Change Documents for System/User Statuses (Trade JEST)
MKPF Header: Material Document
MSEG Document Segment: Material
AFRU Order Confirmations
AFFW Goods Movements with Errors from Confirmations
AFRC Incorrect cost calculations from confirmations
AFWI Subsequently posted goods movements for confirmations

Custom Tables to handle configuration and business process logic, among other tasks, such as:

### Accounts Payable (AP) Specific Tables:

/VAS/PAAP_FIELDS Configure AP Change History Trackable Fields
/VAS/PAAP_VLKP AP Lookup Values Configuration

### Accounts Receivable (AR) Specific Tables:

/VAS/PAAR_FIELDS Configure AR Change History Trackable Fields
/VAS/PAAR_VLKP AR Lookup Values Configuration

### Source to Pay (STP) or Procure to Pay (PTP) Specific Tables:

/VAS/PASTP_FIELDS Configure STP Change History Trackable Fields
/VAS/PASTP_VLKP STP Lookup Values Configuration

### Order to Cash (OTC) Specific Tables:

/VAS/PAOTC_FIELDS Configure OTC Change History Trackable Fields
/VAS/PAOTC_VLKP OTC Lookup Values Configuration

### Plan to Produce (PTP) Specific Tables:

/VAS/PAPTPFIELDS Configure PTP Change History Trackable Fields
/VAS/PAPTP_VLKP PTP Lookup Values Configuration

And, generic tables that may be used across all connectors. For example:

### Generic Tables Across all Connectors:

CDHDR Change document header
CDPOS Change document items
TVFKT Billing: Document Types: Texts
USER_ADDRP Read Name of User
T003T Document Type Texts
DD03L Table Fields
DD04T R/3 DD: Data element texts
DD07V View on fixed values and domain texts
TSTCT Transaction Code Texts
TBSLT Posting Key Names
TTZCU Customizing time zones
   which may be used across all connectors entirely or individually selected in one or more connectors. For example, in one embodiment a group of connectors operating on one or more systems each connector extracting data from tables listed herein specifically for the connector and one or more generic and/or custom tables used by the same connector.

In one embodiment, an automatically created timeline of a document or other process in a system wherein the timeline comprises portions of standard ERP tables and custom tables for at least one of configuration and business process logic.

Although the various embodiments described herein have been with reference mainly (although not entirely) to an SAP ERP it should be understood that the same techniques and processes may be applied to other ERP systems as will be understood to the ordinarily skilled artisan upon review of the present disclosure, as well as to custom management or operational systems tracking any type of performance, quality, costs, or other metrics. Further, as described, a connector is provided for any of Order To Cash (OTC), Accounts Receivable (AR), Source To Pay (STP), Accounts Payable (AP), and Plan to Produce (PTP), each of which may, for example, include a different knowledge table identifying records and/or other data, events, etc. in the source system, and that the same techniques may be directly applied and/or modified for various other processes or documents or process area events within any system. For example, documents or events related to maintenance, equipment use/efficiency, technical support, customer service, product development, or others where, for example, value may be directly extracted or provided to a tool for process intelligence, data mining, process mining, investment analysis, or other operations.

In such operations, in one embodiment, the connector may be configured so as to pull a myriad of SAP tables and put event data together such that all the events for a particular process (e.g., all the events for a sales order, a purchase order, or a manufacturing order for example) and ordering the data so that it can be loaded into a process mining tool (e.g., Blue Prism Process Intelligence, ABBYY Timeline, and/or others) as, for example, timeline event data—which is, for example, event driven data ordered as it occurred from conception (or other defined point in time/process) to completion. The timeline event data may be derived from any of the documents or processes maintained on a source system (including one or more remote systems) and may include, for example, invoices related to utilities, production data (which may be anything related to manufacturing and/or how the manufacturing process operates, for example). In addition to the timeline event data, environmental data or other factors/information may be extracted, ordered, and provided to the tool. For example, In FIG. 4, the knowledge table 452 may point to event data and/or environmental data, and/or other types of data that will be utilized by the tool. The environmental data may be interspersed within the event data (e.g., stitched along with the event data), saved separately and linked to event data, or otherwise provided alone or in conjunction with the event data. In one embodiment, the event driven data includes environmental data and/or calculations/results about items being purchased or the amount of CO2 that may have been generated in a manufacturing process and may not be an event per se, but may be, for example, a rate of emissions over time that may be periodically re-calculated and interspersed with the timeline event data or formatted as an event or separately provided.

In yet another embodiment, a system equipped with a plurality of connectors (e.g., any combination of the above noted connectors or others that may be developed for a specific or general purpose implementation) which may include an interface that operates one or more of the connectors when manually or automatically invoked. The connectors may be configured to provide input to a same or different tools, and the connectors may be automatically invoked upon different conditions. For example, some connectors may be invoked after a predetermined number of hours of production line operation for quality, maintenance, or ROI review, and another connector may be invoked quarterly for compliance or reporting purposes.

In describing the embodiments, and as illustrated in the drawings, specific terminology is employed for the sake of clarity. However, the various embodiments are not intended to be limited to the specific terminology so selected, and it should be understood that the ordinarily skilled artisan may utilize similar, related, or even different terminology depending on the embodiment or selected topic therein to discuss, describe, or when implementing the same. Further, it should be understood that each specific element includes all technical equivalents that operate in a similar manner, as will be understood by the ordinarily skilled artisan. For example, when describing tables, records, transfer, stitching, etc., any other equivalent device, such as a data structures of various forms, systems, communications, or other processes having an equivalent or similar function or capability, whether or not listed herein, may be substituted therewith. Furthermore, newly developed technologies not now known may also be substituted for the described parts and still not depart from the scope of the present application or any of the embodiments. All other described items, including, but not limited to ERP systems, connectors, stitching, information retrieval storage and communication, etc. should also be considered in light of any and all available equivalents.

Portions of the various embodiments may be conveniently implemented using a conventional general purpose or a specialized digital computer or microprocessor programmed according to the teachings of the present disclosure, as will be apparent to those skilled in the computer art.

Appropriate software coding or ERP system programming can readily be prepared by skilled programmers based on the teachings of the present disclosure, as will be apparent to those skilled in the software/ERP arts.

The various embodiments include a computer program product which is a storage medium (media) having instructions stored thereon/in which can be used to control, or cause, a computer to perform any of the processes of the embodiments. The storage medium can include, but is not limited to, any type of disk including floppy disks, mini disks (MD's), optical discs, DVD, HD-DVD, Blue-ray, CD-ROMS, CD or DVD RW+/−, micro-drive, and magneto-optical disks, ROMs, RAMs, EPROMs, EEPROMs, DRAMs, VRAMs, flash memory devices (including flash cards, memory sticks), magnetic or optical cards, SIM cards, MEMS, nanosystems (including molecular memory ICs), RAID devices, remote data storage/archive/warehousing, USB drive, cloud, Google Play Store, or any type of media or device suitable for storing instructions and/or data.

Stored on any one of the computer readable medium (media), the embodiments may include software for controlling both the hardware of the general purpose/specialized computer or microprocessor, and for enabling the computer or microprocessor to interact with a human user or other mechanism utilizing the results of any embodiment or variations/equivalents thereof. Such software may include, but is not limited to, device drivers, operating systems, and user applications. Ultimately, such computer readable media further includes software for performing any embodiment as described above and equivalents thereof.

Included in the programming (software) of the general/specialized computer or microprocessor are software modules for implementing the teachings of the various embodiments, including, but not limited to, identifying tables and/or records, retrieval of tables and/or records (or any other data related to any of the documents or processes hosted, maintained, or performed on an ERP or other system, stitching the retrieved records and applying them to a transfer portal via a file or other communication method, receiving the stitched records by a process mining, process intelligence, or other tool, and applying the results of the tool to improve workflow, processing of the system and the activities it supports along with the display, storage, or communication of results according to the processes as described herein and equivalent processes whether or not described herein.

The various embodiments include those necessarily rooted in computer technology in order to overcome problems specifically arising in the realm of computer networks. For example, application of any of the claims or any embodiment reciting improvements that provide the same. Such improvement include speed of processing and providing fundamental information to a process mining, process intelligence, or other tool/machine greatly reducing the time required to operate the intelligence, get results, and make improvements.

In one embodiment, the various processes or embodiments described herein, individually or combined, are specifically performed via electronics, computer programming, or other devices and specifically exclude any use of behavior, human thought processes, mental process, calculations, or the like—as those terms are either statutorily defined, judicially interpreted, or implicated under 35 USC with respect to patentable subject matter and abstract concepts. For example, in such embodiment, each process (or step of a process, device, or any limitation whether functional or structural) within any claim derived therefrom does not include any mental process, human thought, calculation, or organization (unless specifically included as such). Further, each embodiment described herein includes an alternative, whether or not already described, where one process contained therein does not include any abstract concept, abstraction, human thought, calculation, or organization. Similarly, each embodiment described herein may include alternatives, where any of two, three, or rather any number of processes contained therein in any combination do not include any abstractions, mental process, or human thought, calculation, or organization.

Accordingly, Applicant reserves the right to disclaim any portion of any claim or embodiment from any form of abstraction, mental process, any human thought, any human/mental calculation, or any human/mental/abstract organization from any of the claims now or later presented with respect hereto. Such disclaimer may be specifically applied to a claim as a whole or any part, clause, or limitation individually or in any combination as contained in or be part of any claim.

Applicant hereby asserts that each embodiment described herein along with the various combinations whether or not specifically denoted herein each represent an advance in the field (process mining, intelligence, etc.) and particularly the pathway for transferring ERP system, process, event, and/or document information to a process mining, process intelligence, or other tool. The described embodiments include various combinations of elements (such as steps or elements of the attached claims that may be embodied in one or more clauses therein) each of which are important parts of the advance provided by the combination of elements. Further, while the various elements on their own improve the art and may be utilized in other systems, those elements together, as claimed, represent an important advance that will improve and advance systems of related purposes to which they may be applied, including increased speed and accuracy of providing event driven data, such as timeline event data, to, for example, a process mining or process intelligence.

In an embodiment in support of process mining tools, the Connector will extract various documents (e.g., Accounts Payable (AP), Accounts Receivable (AR), etc.) from an organization's ERP (e.g., SAP) and stitch them together in timestamp order for a particular timeline identifier. The data extracted forms the foundation for process mining tools to analyze areas for process improvement, end user training, or follow-on task mining and RPA solutions. The Connector is, for example, a pre-built connector such that minimal organizational resource time is required to extract meaningful data in support of process mining tools and significantly increased speed to deployment and analysis within process mining tools. The connector further provides, for example, seamless document flows and change log history out of the box, which leads to quicker time to process mining analysis of the extracted data. For organizations with significant customization and/or special fields, the connector may be modified such all meaningful attributes are extracted and properly stitched, and such modifications may include changes to development objects and custom tables within the connector, and changes to handle client specific configurations and custom data dictionary, etc.

The connector may operate, for example, from within an organization's production environment. Adjustments to the selection criteria, scope, etc. may be made, for example, to improve execution time (e.g. limited date or document ranges.) In addition, BASIS changes may be provided, for example, for database tuning. Development changes may include secondary indexes on SAP tables (e.g., for tables with sub-optimal data selection performance). In one embodiment, a modified table or secondary index to improve performance of data selection and/or stitching with a connector. In one embodiment, running a connector in a sandbox or other environment, reviewing execution times associated with extraction from various tables, identifying the lowest performing tables (e.g., at or below a threshold) and indexing those tables in a manner that improves performance. In one embodiment, the connector is a shell, only performing the data extraction to evaluate performance.

In operation, the connector will, for example, extract process area events with timestamp and other attributes useful in analyzing business processes using a process mining tool. A connector for Accounts Receivable (AR) data extraction may, for example, focus on invoice creations through payment receipt events. The connector data can be run with a focus on Order to Cash (OTC) and integrated into an OTC focused process mining project.

The connector may operate at any desired interval. A Proof of Concept (POC) operation may be, for example, a predominantly single point use for a larger subset of an organization's data. For ongoing project work, delta loads can be run periodically (e.g. daily, hourly, etc.) and may depend on business need and the usage of monitoring tools and alerts within the process mining tools. In one embodiment, a connector between an ERP and process mining tool that extracts ERP data (or documents) and stitches them in timeline order transporting the stitched data to a process mining tool, and then re-running the connector at a predetermined interval providing delta data to the tool. The interval may be a set time and/or triggered via an amount or type of activity. In one embodiment, a process mining tool configured to operate on a delta incremental stitched process area events in relation to a previous set of stitched process area events.

Data volume is dependent at an organization may vary by many factors, including but not limited to those parameters and ranges shown on the selection screens (e.g. see figures), and/or frequency of connector operation. The connector can be operated single use for the POC or contract evaluation, or can be setup to run based on delta load criteria. In one embodiment, a connector that is part of an organization's SAP tools and regularly utilized by the organization for on-going analysis and evaluation of operations. In another embodiment, a connector contracted for single use at an organization.

In conjunction with an ERP or other system, a method comprising determining that a plurality of records of a source table are copied from a source system to a target table of a target system, detecting one or more changes that have occurred to at least a subset of records of the plurality of records while the plurality of records are being copied from the source table of the source system to the target table of the target system, populating a change table of the source system, with the one or more changes that were detected to have occurred to the subset of records of the plurality of records while the plurality of records are being copied from the source table of the source system to the target table of the target system, determining that the plurality of changes are copied to a shadow table of the target system, wherein at least a subset of the plurality of changes are copied from the change table to the shadow table while the plurality of records are being copied from the source table of the source system to the target table of the target system, determining that the target table includes the plurality of records from the source table, and merging the plurality of changes of the shadow table with the target table, wherein upon a completion of the merging the shadow table is deleted and subsequent changes to the source table are received and executed on the target table. In one embodiment, the plurality of records comprise process area events in the ERP, documents, or a process within the ERP. In one embodiment, the plurality of records comprise process area events in the ERP, documents, or a process within the ERP reformatted in a timeline—wherein the reformatting may occur in conjunction with or during copying, and the reformatting may comprise stitching the records together in the timeline. In one embodiment, the target system is a process mining or process intelligence tool. In one embodiment, the target system is a process mining or intelligence tool that reformats the received records in a timeline format. In one embodiment, the target system includes or makes use of a converter or connector that places the records in timeline format.

In one embodiment, a method of retrieving a plurality of documents from an SAP system, determining a timestamp associated with each document, stitching the documents (or indicia of each document) together in a timeline according to the timestamps, and entering the stitched documents into a process mining or intelligence tool for evaluation of efficiency or outcomes represented by the timeline.

In one embodiment, a connector configured to extract a plurality of records from multiple tables in a system, stitch the plurality of records together into a timeline, and transfer the stitched timeline to a process mining, process intelligence, or other tool. The connector may be modified for at least one of customer specific configurations, custom data dictionary, and/or other development objects.

In one embodiment, a method of importing a transport package comprising at least one of development objects and custom tables configured to retrieve records and documents from a system hosted on an Enterprise Resource Planning (ERP) platform, modifying the transport package and/or development objects and/or custom tables for extraction of records and/or documents from the hosted system, applying the modified package and/or development objects to retrieve the records and documents, stitching the records and documents together in a timeline according to timestamp data associated with each record and document, entering the stitched records into an intelligence tool configured to compare at least one of a node, document, or process represented by the stitched records and documents to a plurality of data points comprising at least one of same and/or similar nodes, documents, or processes in the same system and the same or similar nodes, documents, or processes in other systems, and preparing for display at least one of a report and a visual representation identifying anomalies within the stitched records and documents. The ERP may be SAP and the retrieved records and document may comprise at least one of sales orders, deliveries, purchase orders, purchase requisitions, payments, invoices, planned orders, production orders, and/or document change headers, names, fields, texts, among other attributes and document data. The ERP may be SAP and the retrieved records and document may comprise at least one of SAP tables/views of CDHDR Change document header, CDPOS Change document items, TVFKT Billing: Document Types: Texts, USER_ADDRP Read Name of User, T003T Document Type Texts, DD03L Table Fields, DD04T R/3 DD: Data element texts, DD07V View on fixed values and domain texts, TSTCT Transaction Code Texts, TBSLT Posting Key Names, and TTZCU Customizing time zones—or other related tables. The visual display may be a flow wherein at least one portion of the flow is highlighted to identify an anomaly.

In one embodiment, a process mining or intelligence tool utilizing an automatically created timeline of events from at least one of a document, series of documents, records, or process reflected in any of documents or records to produce a model of the document or process. The model may be graphically output to a display and include indicia highlighting events or information shown in the model. The highlighted events or information may comprise, for example, statistical variations from a norm established by evaluating a large dataset of similar documents, records, or processes.

In one embodiment, a process mining tool configured to receive an automatically created timeline of events, map the events, analyze and optimize the events, monitor changes in the events based on a newly automatically created timeline of events, alerting to changes or exceeding thresholds in the events, and simulating a document or process memorialized by the events. The automatically created timeline of events may comprise AR records from SAP tables and views. The simulation may comprise a visual representation of a document or process of the timeline of events. The automatically created timeline of events may comprise events extracted and stitched together from a combination of records found in at least three tables or views being the same or similar to SAP tables/views of sales orders, deliveries, purchase orders, purchase requisitions, payments, invoices, planned orders, production orders, and document change headers, among other attributes and document data, etc., including any others described herein or as needed for any particular implementation. The automatically created timeline of events may comprise events extracted and stitched together from a combination of records found in, for example, SAP tables/views of CDHDR Change document header, CDPOS Change document items, TVFKT Billing: Document Types: Texts, USER_ADDRP Read Name of User, T003T Document Type Texts, DD03L Table Fields, DD04T R/3 DD: Data element texts, DD07V View on fixed values and domain texts, TSTCT Transaction Code Texts, TBSLT Posting Key Names, and TTZCU Customizing time zones.

In one embodiment, a process mining, process intelligence, or other tool configured to display at least one of a workflow, process, or portion thereof from a system hosted on an ERP, wherein the workflow, process, or portion thereof comprises automatically generated records stitched together in timeline. The automatically generated records may be stitched together via a connector between the system and the tool. The ERP may be, for example, SAP and the records may be automatically retrieved from a plurality of tables comprising sales orders, deliveries, purchase orders, purchase requisitions, payments, invoices, planned orders, production orders, and/or document change headers, among other attributes and document data, etc. As with other tables discussed herein this a selection that, in most cases, will be driven by the tool. The document data/attributes/etc. meeting any requirements or inputs according to the tool, and comprises identifying the table and data/record/etc. for the tool which is then stitched as needed or desired by the tool. Accordingly, the stitched records for one tool will be different from the stitched records for another tool even if both are stitched in a same timeline type format.

In one embodiment, providing an automatically created stitched timeline of document or process to a first tool and a second automatically created stitched timeline of a document or process to a second tool, wherein the stitched timelines utilize a different set of data retrieved from different tables of a same system in accordance with the tool provided by the respective stitched timelines. Where such document data or other attributes is identified by, for example, a knowledge table corresponding to each tool.

In one embodiment, a method of retrieving a plurality of training records from at least one system hosted on one or more ERPs or other platforms, determining at least one of a set of rules, trends, averages and/or statistical information from the records, automatically retrieving a set of customer records from a customer system hosted on an ERP, and evaluating the customer records with a process mining, process intelligence, or other tool based on rules, trends, averages and/or statistical information from the records. The customer records may be automatically retrieved using a connector configured to retrieve the records from different tables in the customer system and stitch them together for direct use by the tool. The at least one system may be the customer system or a system other than the customer system. The plurality of training records may be automatically retrieved from the at least one system via a connector that stitches together various records from a plurality of tables in (into) a timeline.

In one embodiment, a method comprising creating or updating a training database via a timeline stitched set of records from a plurality of tables in an ERP hosted system, wherein the stitched set of records reflect at least one of a document or process in the system. The stitched records may be automatically generated via a connector that extracts the records from the system and stitches them together into the timeline.

In one embodiment, a client site customization tool configured to modify a connector that automatically extracts records from a system and stitch the records together in a timeline for use in a process mining, process intelligence, or other tool, wherein the modification comprises identifying at least one client site specific configuration, custom data dictionary, and/or other development object, and changing at least one of a retrieval and stitching process in the connector to match the identified development object(s). The changes may comprise, for example, modification to configuration and/or data tables and/or selecting additional fields in the connector corresponding the client site specific configuration. The changes may include modification to a knowledge table or creation of a new knowledge table. The client site customization tool may include a graphical user interface configured to allow definition and selection of ALV layouts (or other parameters) for at least one column used to modify the connector.

In one embodiment, a connector, comprising a graphical user interface including selectable fields for information regarding customized fields and/or tables for a document or process in a source system, an extractor configured to automatically extract baseline information and information contained in the customized fields and/or tables, along with timeline information for the information extracted, a stitching device that places the extracted information in a transport container according to the timeline information, and a transport mechanism configured to output the transport container to a tool. The tool may be, for example, a process mining, process intelligence, or other tool. The user interface may include, for example, a document identifier and indicia specifying a preferred output. The extracted information according to timeline information may comprise an ordered sequence of events as they occurred for the document or process. The transport container may be, for example, a .CSV file. The document or process may be a function or events that relate to one or more digital workers. The document or process may relate to Robotic Process Automation (RPA). The document or process may relate to a physical automation or process performed at a factory, manufacturing facility, or other commercial location. The process mining, process intelligence, or other tool may be configured to evaluate the timeline and produce at least one of a visual model, process improvement, intelligence improvement, robotics, ROI calculation, and alert relative to the document or process. The tool may be configured to provide at least one of feedback, control, and/or maintenance information of a manufacturing machine. The tool may be configured to provide feedback to a software robot. The tool may be configured to provide feedback to a self-driving vehicle. The tool may comprise, for example, a Return on Investment (ROI) indicator for the document or process.

In one embodiment, a method comprising, determining a plurality of records from a plurality of source tables and/or views in a source system wherein each record comprises at least one instance of a document or process, determining a timestamp associated with each record of the plurality of records, stitching the records together in a timeline of records according to the timestamps, and entering the stitched records into a process mining or intelligence tool for evaluation of efficiency or outcomes represented by the stitched records. The plurality of records may, for example, represent a process thread of an account receivable in an SAP system. The plurality of records may, for example, represent a process thread of any of an Account Payable (AP), Account Receivable (AR), Source-To-Pay (STP), Order-To-Cash (OTC), Plan-To-Pay (PTP), or other document or process in an SAP or other system. The plurality of records may be a non-conventional document or process within any system, for example, a customized document flow related to compliance of specific laws or regulatory functions, factory automation, allocations/performance of digital workers, RPA, etc. The stitched records may comprise a .CSV file formatted for an ABBYY process mining or process intelligence tool. The stitched records may be derived from a combination of records found in tables related the document or other process, including, for example, any of sales orders, deliveries, purchase orders, purchase requisitions, payments, invoices, planned orders, production orders, and/or document change headers, among other attributes and document data, etc. In one alternative, at least one table specific to a document or process type to be evaluated and at least one table specific to a customer implementation of the document or process type. The tables may be, for example, derived from a combination of records found in tables (e.g., at least three, or other numerical combination) related or connected to SAP tables/views of CDHDR Change document header, CDPOS Change document items, TVFKT Billing: Document Types: Texts, USER_ADDRP Read Name of User, T003T Document Type Texts, DD03L Table Fields, DD04T R/3 DD: Data element texts, DD07V View on fixed values and domain texts, TSTCT Transaction Code Texts, TBSLT Posting Key Names, and TTZCU Customizing time zones. Identifying the customer implementation specific table may include at least one record contained therein for use in the determining and stitching steps. The tool may provide a visual model of the document or process. The visual model comprises a highlight of a variation in an automatically created stitched timeline compared to averages of other instances of a same document or process. The averages of other instances of a same document or process may comprise averages within the same system from which the automatically created stitched timeline originated. The averages of other instances of a same document or process may comprise averages from one or more systems that are not the same system from which the automatically created stitched timeline originated. The averages of other instances of a same document or process may comprise averages from one or more systems that are weighted based on similarity to the system from which the automatically created stitched timeline originated. The documents may be from SAP and the stitching may comprise placing the documents together in timestamp order for a particular timeline identifier. The records comprise payments, invoices, and document change headers, for example. The tool may comprise, for example, ABBYY Timeline. The tool may comprise, for example, at least one of Blue Prism Process Intelligence, ABBYY Timeline, Workfellow Process Intelligence, Celonis Execution Management System, IBM Process Mining, UiPath Business Automation Platform, Software AG, SAP Signavio, MEHRWERK and/or others.

In one embodiment, a process tool utilizing an automatically created timeline of events from at least one of a document, series of documents, records, or process reflected in any of documents or records to produce a model of the document or process. The model may be graphically output to a display and include indicia highlighting events or information shown in the model. The highlighted events or information may comprise, for example, statistical variations from a norm established by evaluating a large dataset of similar documents, records, or processes.

In one embodiment, a connector comprising a graphical user interface including selectable fields for information regarding customized fields and/or tables for a document or process in a source system, an extractor configured to automatically extract baseline information and information contained in the customized fields and/or tables, along with timeline information for the information extracted, a stitching device that places the extracted information in a transport container according to the timeline information, and a transport mechanism configured to output the transport container to a tool. The tool is, for example, a process mining, process intelligence, or other tool. The user interface may include a document identifier and indicia specifying a preferred output. The extracted information according to timeline information may comprise an ordered sequence of events as they occurred for the document or process. The transport container may comprise a .CSV file. The document or process may relate to a digital worker. The document or process may relate to Robotic Process Automation (RPA). The document or process may relate to a physical automation or a process performed at a factory, manufacturing facility, or other commercial location. The tool (e.g., process mining, process intelligence, etc.) may be configured to evaluate the timeline and produce at least one of a visual model, process improvement, intelligence improvement, robotics, ROI calculation, and alert relative to the document or process. The tool may be configured to provide at least one of feedback, control, and/or maintenance information of a manufacturing machine. The tool may be configured to provide feedback to a software robot. The tool may provide feedback to or comprise a Return on Investment (ROI) indicator for the document or process. The tool may be configured to provide feedback to a self-driving vehicle. The tool may be configured to feedback or control for other life critical components operated by machines or other devices which will improve safety margins (or higher throughput, less defects, better ROI for both life-critical and non-life-critical operations and/or manufacturing/productions) due to the increased speed and accuracy at which the tool may receive information according to the various methods, devices, and processes described herein.

Further, in yet another embodiment, a security arrangement is provided for a connector between an ERP and an intelligence tool that locks the connector to a specific installation (e.g., a lock or related mechanism/verification module contained in the connector). The lock may operate, for example, with a set of keys/encryptions, one of which may be generated at an authorized facility where the connector has been installed and a corresponding key provided from a remote location (e.g., from a licensor), each of which may be communicated over a network to the connector. The verification module disabling the connector if the keys do not match. Accordingly, a key enabled connector that automatically extracts information from a plurality of tables in an ERP or other system that replicates and stitches the information onto an ordered timeline. And, similar to various other of the above embodiments, placing the timeline in a container and transporting it to an intelligence tool for task mining and/or other analysis of the documents and/or processes and/or services and/or maintenance and/or automations and/or other activities represented by the extracted information. In addition to being extracted from multiple tables, such tables (and/or other information) may be hosted on different systems. The key/keys generated may enable such processing or connector throughput from different host systems, for example.

Numerous modifications and variations of each embodiment are possible in light of the above teachings. It is therefore to be understood that within the scope of any claims, the invention, or any embodiment thereof, may be practiced otherwise than as specifically described herein.

1. A method comprising:
determining a plurality of records from a plurality of source tables and/or views in a source system wherein each record comprises at least one instance of a document or process;
determining a timestamp associated with each record of the plurality of records;
stitching the records together in a timeline of records according to the timestamps; and
entering the stitched records into a process mining or intelligence tool for evaluation of efficiency or outcomes represented by the stitched records.

2. The method according to claim 1, wherein the plurality of records represent a process thread of an account receivable, accounts payable, source to pay, order to cash, plan to produce, or any other process area in an SAP system.

3. The method according to claim 1, wherein the stitched records comprise a .CSV file formatted for an ABBYY process mining or process intelligence tool.

4. The method according to claim 1, wherein the stitched records were derived from a combination of records found in tables related or connected to a document or process including at least one of sales orders, deliveries, purchase orders, purchase requisitions, invoices, planned orders, production orders, and document change headers.

5. The method according to claim 4, further comprising at least one table specific to a document or process type to be evaluated and at least one table specific to a customer implementation of the document or process type.

6. The method according to claim 5, further comprising the step of identifying the customer implementation specific table and at least one record contained therein for use in the determining and stitching steps.

7. The method according to claim 1, wherein the process intelligence tool provides a visual model of the document or process.

8. The method according to claim 7, wherein the visual model comprises a highlight of a variation in an automatically created stitched timeline compared to averages of other instances of a same document or process.

9. The method according to claim 1, wherein the documents are from SAP and the stitching comprises placing the documents together in timestamp order for a particular timeline identifier.

10. The method according to claim 9, wherein the process intelligence tool comprises ABBYY Timeline.

11.-13. (canceled)

14. A connector, comprising:
a graphical user interface including selectable fields for information regarding customized fields and/or tables for a document or process in a source system;
an extractor configured to automatically extract baseline information and information contained in the customized fields and/or tables, along with timeline information for the information extracted;
a stitching device that places the extracted information in a transport container according to the timeline information; and
a transport mechanism configured to output the transport container to a tool.

15. The connector according to claim 14, wherein the tool is a process mining or process intelligence tool.

16. The connector according to claim 14, wherein the user interface includes a document identifier and indicia specifying a preferred output.

17. The connector according to claim 14, wherein the extracted information according to timeline information comprises an ordered sequence of events as they occurred for the document or process.

18. The connector according to claim 14, wherein the document or process relates to a digital worker.

19. The connector according to claim 14, wherein the document or process relates to Robotic Process Automation (RPA).

20. The connector according to claim 14, wherein the process intelligence tool is configured to evaluate the timeline and produce at least one of a visual model, process improvement, intelligence improvement, robotics, ROI calculation, and alert relative to the document or process.
